(19) United States
(12) Patent Application Publication
(10) Pub. No.: US 2004/0161338 A1
(43) Pub. Date: Aug. 19, 2004

(54) Structure of a heat sink fan

(76) Inventor: Hsin-Yuan Hsieh, Taoyuan Hsien (TW)

Correspondence Address: RABIN & BERDO, P.C., Suite 500, 1101 14th STREET, N.W., Washington, DC, 20005, US

(21) Appl. No.: 10/419,157

(22) Filed: Apr. 21, 2003

(30) Foreign Application Priority Data
Feb. 14, 2003 (TW) 092202426

(51) Int. Cl. F03B 3/12

(52) U.S. Cl. 416/236 A

(57) ABSTRACT

A structure of a heat sink fan is disclosed. The heat sink fan comprises an axle and a plurality of blades attached to the axle and circling around the axle. A plurality of the protruded portions are formed on a lower side of the blades of the heat sink fan, wherein the protruded portions are bent into an arch shaped directed towards the axle of the heat sink fan. The heat sink fan is placed into a space of a frame in a manner that the heat sink fan can spin axially within the space of the frame for providing cool air.

### BACKGROUND OF THE INVENTION

1. The Field of the Invention

The present invention relates to a structure of a heat sink fan, and more particularly to a structure of a heat sink fan having a plurality of protruded portions at a lower side of the blades of the fan for leading the cool air under the axle in order to effectively improve the heat dissipation efficiency.

2. Description of the Related Art

Recently, as the functions, operating speed and the complexity of the chip of the computer have increased, the heat generated accordingly has also increased. The shape, structure, and the connection aspects of the motherboard of the computer are way more advanced than the old design. Therefore, a method for effective dissipation of heat in order to allow the chip to function normally is a very important issue for the manufacturers. Known heat dissipation method use a heat dissipation unit having a larger base attached to the surface of the heating element of the chip, and a fan positioned on a top surface of the heat dissipation unit to blow cool air onto the heat dissipation unit for dissipating the heat generated by the heating element of the chip in a upwards direction towards the heat dissipation unit. The fan provides cool air to aid spreading the heat towards the surrounding of the heat dissipation unit. As mostly the heating element of the chip is located in a central region of the chip, and therefore the heat of the heating element of the chip is distributed to the heat dissipation unit in a manner that the heat is absorbed by a central region of the heat dissipation unit first and then gets distributed to the surrounding regions of the heat dissipation unit gradually. Therefore, usually the center of the heat dissipation unit takes up higher temperature. The cool air provided by the blades of the fan flows vertically downwards into the heat dissipation unit, therefore the lower portion of the axle of the fan does not generate cool air. Since the axle of the fan is positioned on the central top face of the heat dissipation unit, therefore this arrangement cannot aid effective heat dissipation from the central region of the heat dissipation unit, which takes up higher temperature, thus the heat dissipation efficiency is poor. Accordingly, it is highly desirable to effectively improve the heat dissipation efficiency in order to allow normal functioning of the chip.

### SUMMARY OF THE INVENTION

Accordingly, in the view of the foregoing, the present inventors make a detailed study of related art to evaluate and consider, and uses years of accumulated experience in this field, *p+6Xand through several experiments, to create a new structure of heat sink fan. The present invention provides an innovated structure of heat sink fan having a plurality of protruded portions at a lower side of the blades of the fan for leading the cool air under the axle of the heat sink fan in order to effectively improve the heat dissipation efficiency.

In Accordance with above objects and other advantages of the present invention, a structure of a heat sink fan comprising a plurality of blades attached to an axle and surrounding the axle, is provided. A plurality of protruded portions are formed at a lower side of the blades for leading the cool air under the axle of the heat sink fan to effectively improve the heat dissipation efficiency.

### BRIEF DESCRIPTION OF THE DRAWINGS

For a more complete understanding of the present invention, reference will now be made to the following detailed description of preferred embodiments taken in conjunction with the accompanying drawings, in which:

FIG. 1 is a perspective view of a structure of a heat sink fan of the present invention;

FIG. 2 is a perspective view showing the heat sink fan assembled into a frame according a preferred embodiment of the present invention;

FIG. 3 is a sectional view showing the operation of the heat sink fan of the present invention; and

FIG. 4 is a perspective view of a heat sink fan according to another preferred embodiment of the present invention.

### DETAILED DESCRIPTION OF THE PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

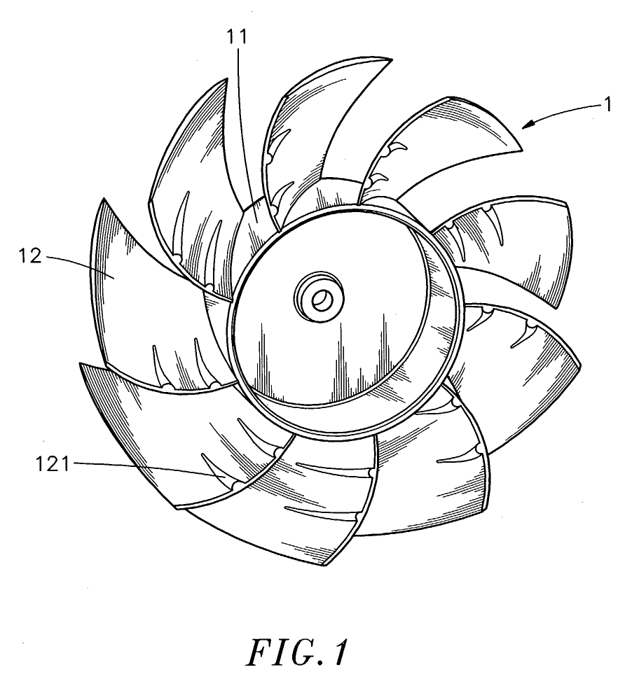

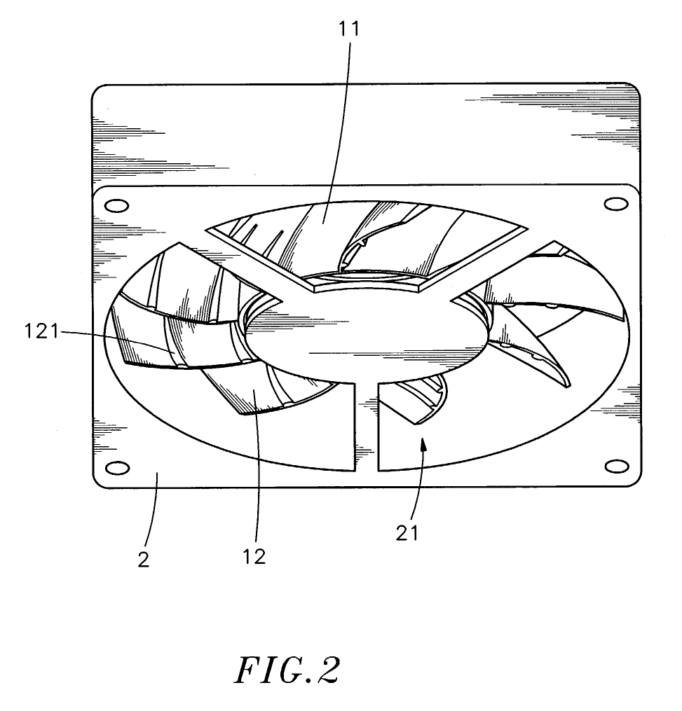

Referring to FIGS. 1 and 2, the heat sink fan 1 of the present invention comprises an axle 11 and a plurality of blades 12 attached around the axle 11 and surrounding the axle 11. A plurality of protruded portions 121 are formed on a lower side of the blades 12 of the heat sink fan 1, wherein the protruded portions 121 are bent into an arch shape directed towards the axle 11 and positioned at a central region of the lower side of the heat sink fan 1.

To assemble the heat sink fan 1 into a frame 2, the heat sink fan 1 is placed into the space 21 located at a central region of the frame 2. In this arrangement, the heat sink fan 1 spins axially within the space 21 of the frame 2 for providing cool air.

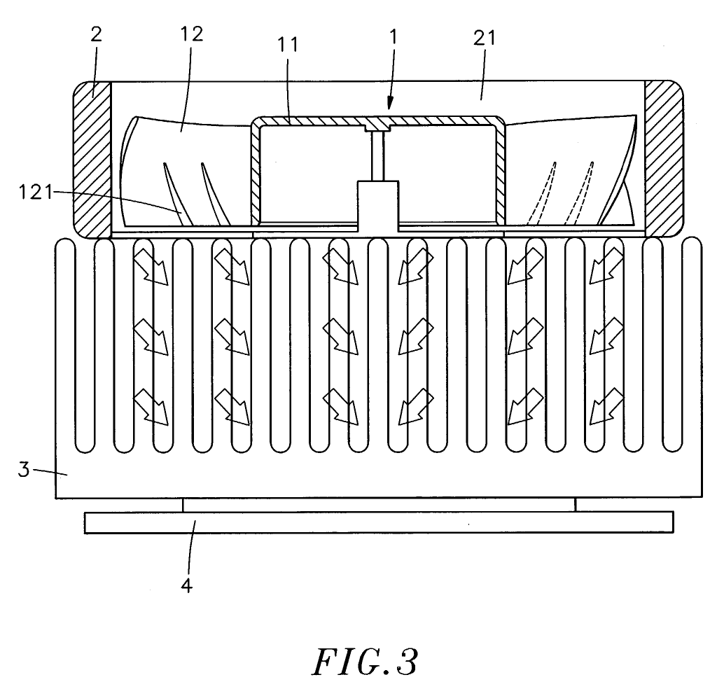

As shown in FIG. 3, after assembling the heat sink fan 1 into the space 21 located at a central region of the frame 2, the heat sink fan 1 is positioned on a top surface of a heat dissipation unit 3, wherein the heat dissipation unit 3 is supported by the surface of a chip 4. Thus, the heat produced by the chip 4 can be conducted by the heat dissipation unit 3 upwards and heat first gets absorbed in the central region of the heat dissipation unit 3 as the chip 4 operates with a high speed. As the heat sink fan 1 is turned on, the heat sink fan 1 spin axially within the space 21 located at the central region of the frame 2, the blades 12 produces cool air which is directed vertically downwards onto the chip 4. Furthermore, when the blades 12 spins to produce cool air, the cool air will be led by the protruded portions 121 that are positioned at a lower side of the blades 12 from the vertical downward direction towards an inward direction. Thus this arrangement would allow the cool air to blow towards the lower side of the axle 11 of the heat sink fan 1 and enters into a central region of the heat dissipation unit 3 to dissipate the heat. Therefore, the heat produced by the chip 4 can removed faster and thus improving the heat dissipation efficiency. Thus, the chip 4 can be effectively protected from breaking down due to over heating.

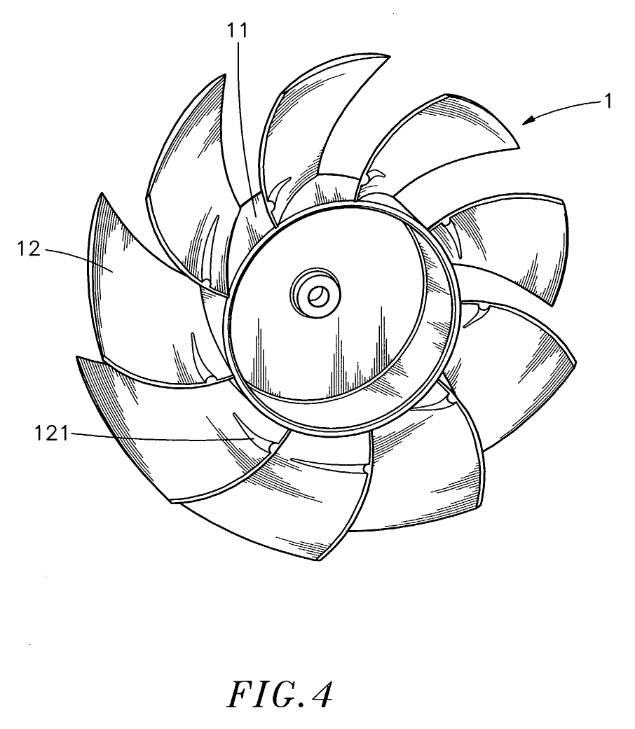

FIG. 4 shows a perspective view of a heat sink fan 1 according another preferred embodiment of the present invention. As shown in FIG. 4, the cool air is led by the protruded portions 121 that are positioned at a lower side of the blades 12 from a vertical downward direction towards an inward direction and into a lower side of the axle 11 of the heat sink fan 1. Therefore, the defects of the conventional design of which cool air is unable to enter to the lower side of the axle 11 of the fan 1 can be substantially overcome. Besides, the number of the protruded portions 121 of the blades 12 may be various according to the requirement of the user. Further, the protruded portions 121 may be an arrayed structure having a plurality of continuous projected points.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A structure of a heat sink fan, comprising:
an axle; and
a plurality of blades attached around the axle and circling around said axle, wherein a plurality of protruded portions are formed on said blades, for distributing cool air produced by said blades while said heat sink fan spins, wherein said protruded portions leads the cool air downwards, directing towards a central region and a lower side of said axle.

2. The structure of a heat sink fan according to claim 1, wherein said protruded portions are positioned at a lower side of said blades and are bent towards said axle.

3. The structure of a heat sink fan according to claim 1, wherein a shape of said protruded portions is comprised of an arch shape.

4. The structure of a heat sink fan according to claim 1, wherein said protruded portions of said blades is arrayed in even distance.

5. The structure of a heat sink fan according to claim 1, wherein said protruded portions of said blades is arrayed by a plurality of continuous projected points.

6. The structure of a heat sink fan according to claim 1, wherein said blades comprises at least one protruded portion.
